(19) United States
(12) Patent Application Publication
(10) Pub. No.: US 2012/0074218 A1
(43) Pub. Date: Mar. 29, 2012

(54) Checkout Methods and Apparatus

(75) Inventor: Robert J. Walsh, Buford, GA (US)

(73) Assignee: NCR Corporation, Duluth, GA (US)

(21) Appl. No.: 12/890,795

(22) Filed: Sep. 27, 2010

(51) Int. Cl. G06Q 30/00; G06K 7/14

(52) U.S. Cl. 235/380; 235/375

(57) ABSTRACT

A system readily adaptable to both periods of normal and peak store activity. A primary barcode scanner is employed to scan most items, and a secondary handheld barcode scanner is employed to scan items, such as large or bulk items left in a customer's shopping cart during normal operation. During peak periods, the secondary handheld barcode scanner is employed by a second store employee to prescan a second customer's items.

### FIELD OF THE INVENTION

The present invention relates generally to improved methods and apparatus for checkout, and more particularly to advantageous techniques for utilizing a cost effective secondary handheld scanner to supplement the use of a primary scanner, such as a counter mounted bi-optic or dual aperture scanner, to speed checkout line processing during times of peak activity.

### BACKGROUND OF THE INVENTION

It is common for a point of sale (POS) checkout system to include two types of barcode scanner: a primary scanner, such as an in-counter bi-optic or dual aperture scanner, and a secondary handheld scanner. The primary scanner is typically utilized for high throughput items and supports the rapid scanning of a large number of items in rapid succession. The secondary handheld scanner is typically employed to scan heavy, bulky items that are more efficiently scanned in a customer's cart, such as a large bag of dog food, a 24 pack of bottled water, a large potted plant, and the like. In such an arrangement, the operator removes the handheld scanner from a cradle or simply picks it up from a convenient resting place, scans the item or items to be scanned thereby, and then returns the scanner to the cradle or puts it down. The overall purchase receipt integrates the scanned data from the primary and secondary scanners. One example of such an arrangement is described in U.S. Pat. No. 7,546,953 which is assigned to the assignee of the present invention and incorporated by reference herein in its entirety.

It is also known that prescanning customer merchandise can be advantageously employed in a variety of contexts, such as, handling the lines presented during peak store sales periods, such as the peak Christmas selling days or during major sales, for example. By way of example, U.S. Pat. No. 7,575,161 describes a cart and scanner arrangement for prescanning and bagging a customer's items to speed the checkout process. Casio Electronics Co. Ltd. describes a queue busting approach utilizing a rugged Pocket PC terminal, the IT-700 series. Such approaches utilize a relatively expensive bar code scanner or other equipment to build up a transaction receipt.

### SUMMARY OF THE INVENTION

Among its several aspects, the present invention recognizes that such prior at approaches may require too great an investment in additional equipment that may only be needed at certain times of day or during particular times of year. As a consequence, the present invention focuses on approaches to leverage existing store equipment with either a simple software upgrade, or in which a substantially reduced investment in further equipment is required as compared with approaches like the Casio Electronics Co. Ltd. approach described above.

According to one aspect of the invention, a checkout system is provided which comprises a primary bar code scanner for rapidly scanning a majority of items of a first customer; a secondary handheld bar code scanner for scanning other items, such as large and bulky items, of the first customer during periods of normal operation; means for detecting that the secondary handheld bar code scanner is being utilized to scan items of a second customer during periods of peak operation; and control means for integrating data from the primary bar code scanner and the secondary handheld bar code scanner during periods of normal operation, and segregating the data from the primary barcode scanner and the secondary handheld scanner upon detecting the secondary handheld scanner is being utilized to scan items of the second customer.

A more complete understanding of the present invention, as well as further features and advantages of the invention, will be apparent from the following Detailed Description and the accompanying drawings.

### BRIEF DESCRIPTION OF THE DRAWINGS

FIG. 1 illustrates a checkout system in accordance with a first embodiment of the invention;

FIG. 2 illustrates a checkout method in accordance with the present invention;

FIG. 3 is a block diagram of part of a control system for a primary scanner in the checkout system of FIG. 1; and

FIG. 4 illustrates a second checkout system in accordance with a second embodiment of the invention.

### DETAILED DESCRIPTION

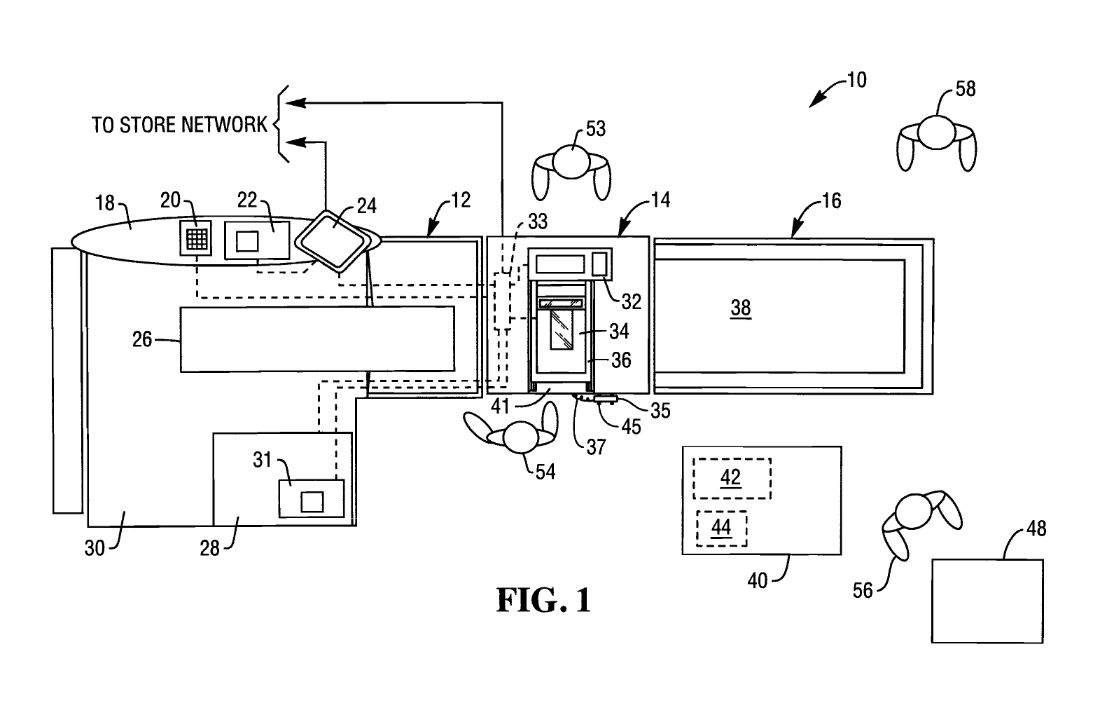

Referring now to FIG. 1, system 10 is configured as a full-service checkout island and includes bagging portion 12, scanning portion 14, and receiving portion 16.

Bagging portion 12 includes customer service table 18, conveyor 26, cash drawer 28, bagging shelf 30, and receipt printer 31.

Customer service table 18 provides a convenient writing surface and includes card reader with pin keypad 20, customer receipt printer 22, and customer display 24.

Card reader 20 is operational in both full and self-service configurations.

Printer 22, though present in the full-service configuration, is intended primarily for operation as a receipt printer during the self-service mode of operation. Printer 31 is used for full-service operation.

Customer display 24 operates as a customer information terminal during full-service operation and a customer-operated transaction terminal during self-service operation. Customer display 24 is preferably connected to a store network. An NCR 7401 computer terminal is suitable for use as customer display 24.

Conveyor 26 supports and transports merchandise items to bagging shelf 30. Conveyor 26 preferably telescopes to allow a portion of bagging portion 12 to be lowered to become a bagging shelf in the self-service mode of operation.

Cash drawer 28 is operated by a full-service checkout employee and allows the employee to process cash and check payments and dispense change.

Scanning portion 14 includes terminal interface 32, a primary dual aperture bar code scanner 34, a secondary handheld bar code scanner 35, and terminal 33.

Terminal interface 32 provides an operator with control during a full-service checkout operation. Terminal interface 32 includes either a display and keypad or a touch screen and is mounted above the vertical aperture portion of dual aperture bar code scanner 34. An NCR Dynakey® terminal is suitable for use as terminal interface 32 although it will be recognized other terminals may also suitably be employed.

Dual aperture bar code scanner 34 includes a vertical aperture and a horizontal aperture. The horizontal aperture is substantially flush with the top surface of scanning portion 14 and may be part of a scale weigh plate if dual aperture bar code scanner 34 is equipped with a scale. An NCR 7875 scanner is suitable for use as scanner 34.

The vertical aperture and its associated scanner housing portion are above the top surface of scanning portion 14. The vertical aperture faces an operator during scanning. Thus, in the full-service configuration of FIG. 1, full-service checkout employee 54 can easily scan merchandise items using scanning light beams from both vertical and horizontal apertures.

Terminal 33 is located within scanning portion 14. Terminal 33 is preferably connected to a store network. During full-service operation, terminal 33 controls card reader 20, cash drawer 28, receipt printer 31, terminal interface 32, primary dual-aperture scanner 34 and second handheld bar code scanner 35.

Receiving portion 16 includes conveyor belt 38.

During full-service operation, customer 53 approaches receiving portion 16 on one side as shown, and places most merchandise items on conveyor belt 38. Large and bulky items are left in a shopping cart 40 which goes to the other side of the checkout stand used by employee 54 as represented schematically in FIG. 1. Employee 54 scans bar coded merchandise items taken from the conveyor belt 38 using dual aperture bar code scanner 34. Employee 54 may alternatively process bar coded merchandise items by entering price look-up numbers into terminal interface 32. Employee 54 also processes non-bar coded items, such as produce items using the scale of dual aperture bar code scanner 34 and terminal interface 32. Employee 54 moves all the processed merchandise items from conveyor 38 to bagging portion 12.

Having processed all of the items from conveyor 38, the employee 50 now turns to any large or bulky items left in the cart 40, such as a fifty pound sack of dog food 42 and a 24 pack of bottled water 44 left on the cart 40. To process these items, store employee 54 removes handheld bar code scanner 35 from its cradle 45 and scans the bar codes for the items 42 and 44 while they are still on the cart 40.

As seen in FIG. 1, the handheld bar code scanner 35 is connected by a flexible and lengthy extendible cord 37 to an input, such as a USB port, of the dual aperture scanner 34. Alternatively, cord 37 may connect scanner 35 to a USB port or other connector of the terminal 33. A processor in dual aperture scanner 34 combines the scan data from the handheld scanner 35 with the data from dual aperture scanner 34 and the combined data is output to and processed by the terminal 33 to produce a customer transaction receipt.

Customer 53 moves to customer service table 18 to wait for all items to be processed by employee 54 and to complete payment. While waiting, customer 53 may view promotional material displayed by display 24 or use customer display to find information about products, answer surveys, or select coupons. Payment may be recorded by card reader 20.

Following payment, employee 54 hands a transaction receipt from receipt printer 31 to customer 53. Customer 53, service person 54, or another store employee charged with bagging items then removes the items from bagging portion 12 and bags them.

Further details of the system 10 are found in U.S. Pat. No. 6,286,758 which is assigned to the assignee of the present application and incorporated by reference herein in its entirety. In the system shown and described in U.S. Pat. No. 6,286,758, the scanner 34 can be rotated to face the customer as further described therein for use in a self-checkout mode of operation.

It will be appreciated that the operation of FIG. 1 up to this point is conventional and typical of how a store might handle a normal period of business. However, in accordance with the present invention, the system 10 has been modified to advantageously be readily adaptable to periods of peak business and long customer lines without the addition of any hardware as follows. As seen in FIG. 1, in the event of a customer line deemed to be too long, a second store employee 56 utilizes the handheld scanner 35 to pre scan items from cart 48 for a next customer 58 in line behind customer 53. In this instance, extensible cord 37 is long enough to readily extend to the cart 48 for the next customer.

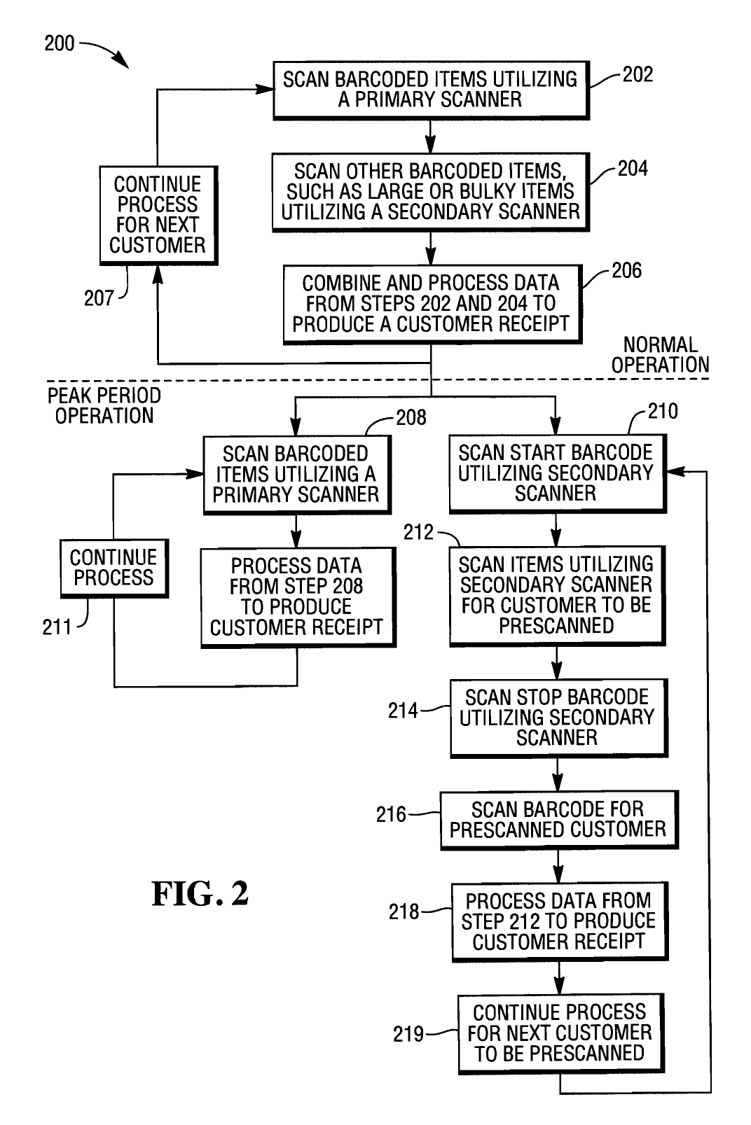

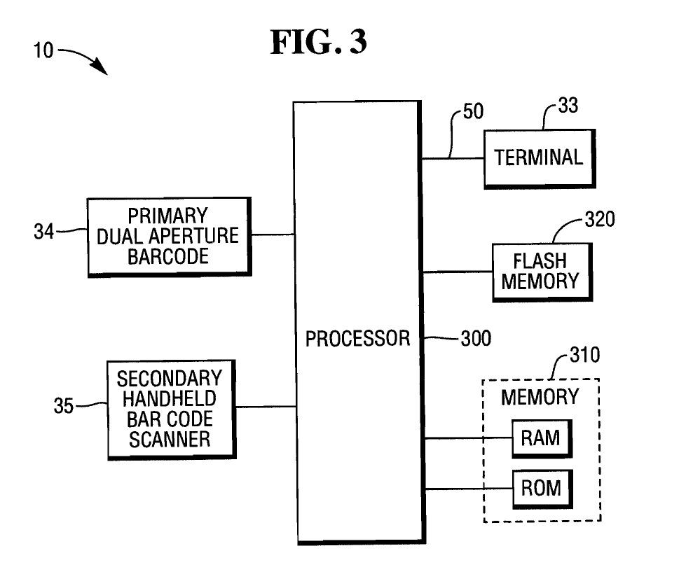

To distinguish items of the second customer 58 from items of the first customer 53, the store employee 56 may scan a customer identifier, such as a bar code from a customer loyalty card before that customer's first item is scanned and again after the last item is scanned. Alternatively, store employee 56 may scan a bar coded card at start and end of scanning the second customer's items and then give the bar coded card to the second customer to present to store employee 54 to identify the customer. These start and stop bar code scans can be recognized by the processor of dual aperture scanner 34 because its software has been updated appropriately in accordance with the present invention, as addressed further below in connection with FIGS. 2 and 3. A suitably programmed processor comprises an example of control means for integrating data from the primary bar code scanner and the secondary handheld scanner during periods of normal operation, and segregating the data from the primary bar code scanner and the secondary handheld scanner upon detecting the secondary scanner is being utilized to scan items of the second customer.

Upon first recognition of a customer identifier as the start code for the second customer 58, the processor segregates the data for the first customer 53 from that of the second customer 58 rather than combining the data from the handheld scanner 35 with the data for the dual aperture scanner 34 as is normally the case for a single customer. Similarly, if the terminal 33 receives the data from handheld scanner 35 directly, it has its software updated to recognize the customer identifier as the start and stop codes for data for a second customer so that data is segregated from data for the first customer by a processor in terminal 33.

After the store employee 56 completes the pre scanning of the items in cart 48, the customer loyalty card is returned to second customer 58 who simply presents that card to store employee 54 once customer 53 is done. The loyalty card is scanned using dual aperture scanner 34 and the data for customer 58 is communicated to the terminal 33 and processed to generate a transaction receipt. While customer 58 is being helped by employee 54, the next customer in line can start loading items on conveyor belt 38 and employee 56 can start pre scanning the items for the next customer after that.

FIG. 2 illustrates an example of a checkout process 200 at a checkout stand, such as stand 10, in accordance with the present invention. During a period of normal operation of a store, in step 202 of process 200, bar coded items are scanned utilizing a primary scanner by a first store employee, such as dual aperture scanner 34, for example. In step 204, other barcoded items, such as large or bulky items are scanned utilizing a secondary handheld scanner, such as scanner 35, for example. In this example, raw bar code data may be provided directly from the secondary handheld scanner to the primary dual aperture scanner. In step 206, bar code data from steps 202 and 204 is combined and processed to produce a customer receipt. In step 207, the process repeats for the next customer.

Upon recognition of there being excessively long lines of customers during a period of peak operation, a second store employee is dispatched to the checkout stand and the process 200 continues, in step 208, with bar coded items for a first customer scanned utilizing the primary scanner by the first store employee. In steps 210-214, bar coded items for a next customer in line are pre scanned by the second store employee utilizing a handheld scanner. To prevent data from the handheld scanner from being automatically combined and processed with the data from the primary scanner, in step 208, the second store employee scans a customer identifier utilizing the handheld scanner. This identifier functions as a start code. In step 210, the second customer's items are pre scanned. In step 212, the customer identifier is scanned again and recognized as a stop code.

Where a store utilizes a customer loyalty card having a bar code, that bar code may be suitably employed as the customer identifier and serve as both the start and stop codes. In stores lacking bar coded loyalty cards or where not all customers have them which is typically the case, the second store employee may have a stack of bar coded cards which he or she scans at the start and stop of pre scanning a next customer's items. It will be recognized that separate start and stop codes may be employed if desired. Further, a temporary interruption code may be employed to allow the second store employee to stop pre scanning to allow the first store employee to scan large or bulky items.

Upon completion of pre scanning, the pre scanned customer receives his or her loyalty card back or the bar coded card which is then scanned in step 216 by the first store employee to check out the pre scanned customer. The data from step 212 is processed in step 218 to produce a customer receipt. Payment is made and a receipt is provided. In step 219, the pre scanning process continues for the next customer to be prescanned.

In one embodiment, the present invention adds new intelligence to the application software of the primary dual aperture scanner 34. As seen in the simplified FIG. 3 which shows illustrative components relative to combining or segregating the primary and secondary scanner data as needed, processor 300 receives inputs from primary dual aperture bar code scanner 34, and secondary handheld bar code scanner 35. It provides outputs on line 50 which is connected to an input of terminal 33. Processor 300 has software memory 310 storing software which when executed controls the processor 300 to perform the methods and processes described further herein. It additionally has flash memory 320. When processor 300 has not received a start or stop code from handheld bar code scanner 35, it outputs its own scan data, as well as, any received from scanner 35 on output line 50. When a start code is recognized, data received from scanner 35 is stored in the flash memory 320 until a stop code is detected. Once a stop code is detected, data from the flash memory is output to terminal 33. For example, a pre scanned customer presents his customer loyalty card to the store employee who scans it and the data from flash memory 320 is output. Subsequently, data from handheld scanner 35 is again directly output on line 50 to terminal 33.

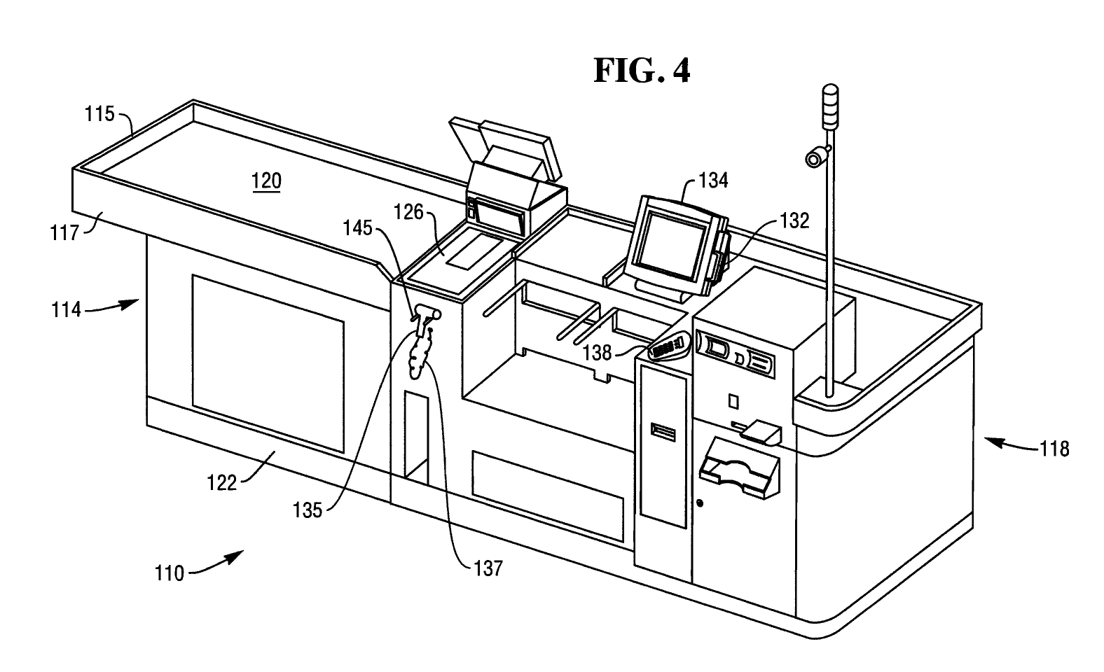

FIG. 4 illustrates a further checkout system 110 in accordance with a second embodiment of the present invention. Checkout station 110 may suitably include a feeder unit 114 and a checkstand 118. Feeder unit 114 includes a feeder belt 120 and housing 122 for the motor and control circuitry that operates feeder belt 120. Checkstand 118 includes a primary scanner/scale unit 126 and a secondary, handheld scanner 135. In FIG. 4, the secondary scanner 135 is a connected to a port of POS terminal 138, such as a USB connector, by a flexible extensible cord 137 and held in a cradle 45 when not in use. The primary scanner scale unit 126 is also connected to terminal 138. Scanner/scale unit 126 uses a laser to scan and obtain input data from bar codes applied to products or packages. Unit 126 may also include a scale for measuring the weight of articles that are sold on a price/unit of weight basis. Consumer terminal 134 displays article data as it is entered through scanner/scale unit 126. Terminal 138 may be any known POS terminal that incorporates a card reader 132 to support credit card, debit card, and other payment methods. A receipt printer 144 provides a consumer with a receipt itemizing the articles purchased and the method of payment. Further details of check stand 110 are found in U.S. Pat. No. 7,673,796 assigned to the assignee of the present invention and incorporated by reference herein in its entirety. In this embodiment, a processor in the terminal 138 aggregates of segregates the data. While a wired handheld scanner is presently preferred as a lowest cost alternative, it will be recognized a wireless scanner may also be employed if its cost is acceptable.

While the present invention has been disclosed in the context of various aspects of presently preferred embodiments, it will be recognized that the invention may be suitably applied to other environments consistent with the claims which follow. For example, while the present invention has been described in the context of bar coded loyalty cards or a stack of bar coded cards to uniquely identify prescanned customers and twin data, it will be recognized that an RFID card or other identifier might suitably be employed.

I claim:

1. A checkout system comprising:
a primary bar code scanner for rapidly scanning a majority of items of a first customer;
a secondary handheld bar code scanner for scanning other items, such as large and bulky items, of the first customer during periods of normal operation;
means for detecting that the secondary handheld bar code scanner is being utilized to scan items of a second customer during periods of peak operation; and
control means for integrating data from the primary bar code scanner and the secondary handheld bar code scanner during periods of normal operation, and segregating the data from the primary barcode scanner and the secondary handheld scanner upon detecting the secondary handheld scanner is being utilized to scan items of the second customer.

2. The checkout system of claim 1 wherein the primary bar code scanner is a dual aperture scanner having a substantially horizontal surface flush mounted with a checkout stand.

3. The checkout system of claim 1 wherein the secondary handheld bar code scanner is utilized to read a start bar code before starting to scan items of the second customer, and to read a stop bar code after finishing scanning items of the second customer.

4. The checkout system of claim 3 wherein a bar code on a customer loyalty card is utilized as the start bar code and the stop barcode.

5. The checkout system of claim 1 wherein the secondary handheld bar code scanner is connected to the primary bar code scanner by a long, flexible, extensible cord.

6. The checkout system of claim 1 wherein the control means is a processor in point-of-sale terminal.

7. The checkout system of claim 6 wherein the handheld bar code scanner is connected to a port of the terminal and provides raw barcode scan data directly thereto.

8. The checkout system of claim 1 wherein the secondary handheld bar code scanner is connected to a port of the primary bar code scanner and provides raw bar code scan data directly thereto.

9. The checkout system of claim 1 wherein the control means is a processor in the primary bar code scanner.

10. The checkout system of claim 9 wherein the processor recognizes a unique customer identifier received by the primary bar code scanner from the secondary bar code scanner as a start code and stores data received from the secondary bar code scanner in a memory until a stop code is recognized.

11. The checkout system of claim 1 wherein the secondary handheld scanner communicates raw scanned data wirelessly.

12. A checkout method comprising:
rapidly scanning a majority of items of a first customer utilizing a primary bar code scanner;
scanning other items, such as large and bulky items, of the first customer during periods of normal operation utilizing a secondary handheld bar code scanner;
detecting that the secondary handheld bar code scanner is being utilized to scan items of a second customer during periods of peak operation;
integrating data from the primary bar code scanner and the secondary handheld bar code scanner during periods of normal operation; and
upon detecting the secondary handheld scanner is being utilized to scan items of the second customer, segregating the data from the primary barcode scanner and the secondary handheld scanner.

13. The method of claim 12 wherein the primary bar code scanner is a dual aperture scanner having a substantially horizontal surface flush mounted with a checkout stand.

14. The method of claim 12 further comprising utilizing the secondary handheld bar code scanner to read a start bar code before starting to scan items of the second customer, and to read a stop bar code after finishing scanning items of the second customer.

15. The checkout system of claim 14 wherein a bar code on a customer loyalty card is utilized as the start bar code and the stop barcode.

16. The method of claim 12 further comprising providing raw bar code scan data directly from the handheld bar code scanner to a port of a point-of-sale terminal.

17. The method of claim 12 further comprising providing raw bar code scan data directly from the secondary handheld bar code scanner to a port of the primary bar code scanner.

18. The method of claim 12 further comprising utilizing a processor in the primary bar code scanner to control integrating and segregating the data.

19. The method of claim 18 further comprising utilizing the processor to recognize a unique customer identifier received by the primary bar code scanner from the secondary bar code scanner as a start code and storing data received from the secondary bar code scanner in a memory until a stop code is recognized.

20. The method of claim 12 further comprising communicating raw scanned data wirelessly by the secondary handheld scanner.
